(19) United States
(12) Patent Application Publication
(10) Pub. No.: US 2026/0244931 A1
(43) Pub. Date: Aug. 20, 2026

(54) INDUCTION COIL ASSEMBLY, METHOD FOR MONITORING AN INDUCTIVE HEATING PROCESS FOR AN INDUCTION COIL ASSEMBLY, SELF-LEARNING SYSTEM FOR MONITORING AN INDUCTIVE HEATING PROCESS, AND METHOD FOR TRAINING THE SELF-LEARNING SYSTEM

(71) Applicant: Haimer GmbH, Hollenbach-Igenhausen (DE)

(72) Inventor: Antonin Podhrazky, Jemnice (CZ)

(21) Appl. No.: 19/541,671

(22) Filed: Feb. 17, 2026

(30) Foreign Application Priority Data
Feb. 14, 2025 (DE) 10 2025 105 702.8

(51) Int. Cl. G06N 3/084

(52) U.S. Cl. CPC G06N 3/084

(57) ABSTRACT

An inductive heating process for an induction coil assembly is monitored via at least one, or several, characteristic variables of the induction process, such as a coil current, a coil voltage, an input current, an input voltage, a link circuit current, and/or a link circuit voltage. The characteristic variable is supplied to a self-learning system, in particular a neural network, where a monitoring characteristic variable is determined from the one or more characteristic variables, such as a temperature characteristic variable of the sleeve portion inserted into the induction coil and/or a sleeve characteristic variable of the sleeve portion inserted into the induction coil and/or a time characteristic variable for the heating process of the sleeve portion inserted into the induction coil .

### CROSS-REFERENCE TO RELATED APPLICATION

This application claims the priority, under 35 U.S.C. § 119, of German Patent Application DE 10 2025 105 702.8, filed February 14, 2025; the prior application is herewith incorporated by reference in its entirety.

### FIELD AND BACKGROUND OF THE INVENTION

The invention relates to an induction coil assembly and to a method for monitoring an inductive heating process for an induction coil assembly. The invention further relates to a self-learning system for monitoring an inductive heating process and to a method for training the self-learning system.

Generic induction coil assemblies are known from applicant’s earlier developments, such as, from United States Patent No. US 9,278,414 B2 and its counterpart European patent application EP 1 867 211 A1.

These known induction coil assemblies are used to thermally expand tool holders by means of alternating magnetic fields that are generated by induction coils and the eddy currents thereby induced in the tool holders inserted in the induction coils of the induction coil assemblies, in order to be able to insert a tool into the tool holder in this expanded state thereof, the tool then being held firmly and symmetrically by the tool holder after a cooling process of the tool holder. This process is also referred to - for short - as inductive shrink-fitting of tools in tool holders, and is known as such.

For a more detailed description of the technical and operational background, reference should therefore be made to the above-mentioned disclosure, which is herewith incorporated by reference.

In such a known induction coil assembly, however, the problem arises that, for efficient operation thereof, that is to say the inductive shrink-fitting of tools into tool holders, in particular during heating of the tool holders, the induction coil assembly needs to be adjusted with regard to various operating or shrinkage parameters, such as in particular also a heating duration (or a shrinkage/heating frequency, a shrinkage/heating temperature, a maximum time for the heating process or a (shrinkage/heating) energy), in each case individually to the tool holder currently/presently held therein, which requires a high degree of manual intervention and thus under certain circumstances significantly extends the cycle times for changing a tool in different types of tool holders. Beyond this, manual interventions are also always potential sources of errors.

On the other hand, if such an adjustment is not carried out, or is carried out incorrectly, on the tool holder currently being held, the operation of the induction coil assembly may be inefficient under certain circumstances, since the intended eddy currents are not induced appropriately in the tool holder. In particularly unfavorable cases, such as for example in the event of excessively long heating durations, the tool holder may even overheat and thus be damaged and destroyed.

Furthermore, self-learning systems are known. A self-learning system is a system that is capable of learning from experience or data and thus automatically improving itself without the need for explicit programming instructions. These systems adapt their functioning on the basis of new information in order to optimize their performance.

A common example of self-learning systems are machine learning algorithms (such as neural networks, decision trees, or support vector machines) that can recognize patterns from large amounts of data and make predictions or decisions. In contrast to traditional programs, where all rules and procedures are defined in advance, self-learning systems improve through ongoing training and can increase their predictive accuracy or efficiency the more they are confronted with data.

For example, a self-learning system might thus be able to classify images, translate texts or even make decisions in a dynamic environment without the need for a human to intervene constantly.

A neural network – as mentioned above, for example – is, as is likewise known from the prior art, a model of machine learning inspired by the functioning of the human brain.

Such a neural network consists of interconnected "neurons" organized in multiple layers in order to process data and recognize patterns. This type of network is particularly well suited to tasks such as image recognition, language processing, translations or predictions.

The main components of a neural network are the afore-mentioned neurons, structured in layers (input or output layer, hidden layers). The neurons (nodes) represent the basic processing units of the network. Each neuron receives input data, performs a calculation, and passes on a result to the neurons in the next layer.

An input layer obtains the input data (for example an image or text) and forwards said data to the next layer. An output layer outputs the final result or the prediction of the model, e.g. the classification of an image. Hidden layers are located between the input and output layers and perform the main calculations. These layers extract complex patterns and features from the input data.

Each connection between neurons has a weight that determines how strongly the signal is transmitted from one neuron to the next. In addition, there is a bias that contributes to shifting the result of a neuron and increasing the flexibility of the model.

After a neuron has processed the input data, an activation function is often applied, which decides whether or not the neuron activates (i.e. "fires"). Examples of activation functions are the sigmoid function, ReLU (Rectified Linear Unit), and tanh.

A neural network is improved by training. Large amounts of data are used to adapt the weights and biases so that the network can make predictions or classifications as accurately as possible. This process is generally effected by a method called backpropagation, in which the error between the predictions of the network and the actual results is propagated backward through the network in order to adapt the weightings.

Neural networks, especially deeper networks (so-called deep learning networks), can accomplish very complex tasks with high accuracy; but they also require large amounts of data and considerable computing resources.

Decision trees are also known as a self-learning system. Especially in artificial intelligence and specifically in machine learning, the decision tree is a popular algorithm for classification and regression.

A decision tree is a systematic model for the presentation and analysis of decision processes. It represents decisions and their possible consequences in a tree-like structure. The starting point is a start node, from which various branches representing different action options or events branch out.

A distinction is made between decision nodes (usually represented as a square), where a conscious choice is made, and random nodes (usually represented as a circle), where different events may occur with particular probabilities. The endpoints of the tree show possible results, which are often evaluated with costs, benefits or profits.

Decision trees are used to make complex decisions transparent, compare alternatives, and choose the best action option on the basis of probabilities and expected results.

Decision trees are trained – like other self-learning systems, too, e.g. neural networks (see above). Well-known training methods/algorithms available for this purpose are, for example, top-down induction (recursive partitioning), C4.5 and successors (e.g. CART, ID3), bagging (bootstrap aggregation), random forest or boosting (e.g. AdaBoost, gradient boosting).

Furthermore, implementation methods are known for designing and optimizing structures of decision trees, e.g. Scikit-learn.

In particular, Scikit-learn (or Sklearn) thus provides a suitable implementation of the (above-mentioned) CART algorithm (Classification and Regression Trees), which can be used for both classification and regression problems.

With Scikit-learn, decision trees can be easily trained by passing the data and target variables to the appropriate classes (e.g. DecisionTreeClassifier or DecisionTreeRegressor). Scikit-learn undertakes the calculation of criteria such as Gini impurity or information gain in order to find the best splits.

### SUMMARY OF THE INVENTION

The object of the present invention is to provide an induction coil assembly and a method for monitoring an inductive heating process for an induction coil assembly and also a self-learning system for monitoring an inductive heating process and a training for such a self-learning system which can overcome the aforementioned disadvantages of such induction coil assemblies known from the prior art, wherein the induction coil assembly in particular can have an increased degree of automation and can thus be operated – process-reliably – with shorter cycle times with high operational safety.

With the above and other objects in view there is provided, in accordance with the invention, an induction coil assembly and a method for monitoring an inductive heating process for an induction coil assembly and also by a self-learning system for monitoring an inductive heating process and a method for training such a self-learning system. Advantageous developments of the invention are the subject of several dependent claims and the following description and relate both to the induction coil assembly and to the method for controlling an inductive heating process for an induction coil assembly and also to the self-learning system for monitoring an inductive heating process and the method for training the self-learning system.

Any relative terms that are used in this specification, such as top, bottom, front, back, left or right - unless explicitly defined otherwise - should be understood in the conventional way – including with regard to the present figures. Terms such as radial and axial, where used and not explicitly defined otherwise, should be understood in relation to center axes, or axes of symmetry, of component parts/components described here – including with regard to the present figures.

The expression “substantially” - where used - may be understood to mean “to a practically still significant degree.” Possible deviations from exactness that are thus implied by this concept may arise unintentionally (that is to say without any functional basis) owing to manufacturing or assembly tolerances or the like.

The induction coil assembly and also the method for monitoring an inductive heating process for an induction coil assembly provide an induction coil in the induction coil assembly into which a sleeve portion of a tool holder is able to be inserted.

A primarily important core of the invention is the self-learning system, in particular a neural network or a decision tree, to which at least one characteristic variable, in particular a plurality of different characteristic variables, of the induction process, specifically a current and/or a voltage, such as in particular a coil current and/or a coil voltage and/or an input current and/or an input voltage and/or a link circuit current and/or a link circuit voltage, is/are or can be provided.

Furthermore, at least one further characteristic variable, such as an instantaneous change of the coil current and/or an instantaneous change of the link circuit current and/or an instantaneous rate of change of the coil current and/or an instantaneous rate of change of the link circuit current and/or an absolute coil voltage and/or an absolute coil current and/or an energy from a coil current that has been flowing since the start of heating and/or an energy from a link circuit current that has been flowing since the start of heating and/or an integral of the instantaneous coil current (active current) that has been flowing since the start of heating and/or an integral of the link circuit current that has been flowing since the start of heating and/or a heating time since the start of heating and/or an instantaneous inductance of the induction coil or of an overall system comprising the induction coil and the sleeve portion and/or an instantaneous phase angle between an instantaneous coil current (active current) and a coil voltage driving it, can also be provided to the self-learning system, in particular the neural network or the decision tree.

A further such characteristic variable (which is to be provided/providable to the self-learning system, in particular the neural network or the decision tree) can be a time (duration) within which the coil current or link circuit current experiences a predefinable change, for example an increase. For example, this can be the time (duration) that the coil current or link circuit current requires to rise from a first (lower) limit value, such as 0 A, to a second (upper) limit value, such as a maximum predefinable current intensity. This would be the case, for example, with a coil current or link circuit current with an applied test pulse (see later with regard to the test pulse).

This self-learning system, using the at least one characteristic variable or the plurality of different characteristic variables (if appropriate also further with the at least one further characteristic variable), then ascertains a monitoring characteristic variable, such as a temperature characteristic variable of the sleeve portion inserted into the induction coil and/or a sleeve characteristic variable of the sleeve portion inserted into the induction coil and/or a time characteristic variable for the heating process of the sleeve portion inserted into the induction coil.

The term "characteristic variable" used in the invention may denote a (one-dimensional) value or (multi-dimensional) vector of a (process) quantity or variable, in particular of a variable changing over time, such as a current, a voltage, a temperature, an inductance or an energy or the like.

The self-learning system or the neural network/decision tree can be optimized if a plurality of hidden layers, in particular of more than 10 hidden layers, in particular of more than 15 hidden layers, in particular of more than 20 hidden layers, in particular of more than 25 hidden layers, more particularly of more than 30 hidden layers, very particularly of 32 hidden layers, are used.

Moreover – in order to further improve the self-learning system or the neural network – it is advantageous to use an ReLU function and/or a sigmoid function as an activation function.

The self-learning system or the neural network/decision tree, using the aforementioned characteristic variables, can be trained (method for training the self-learning system) – with the aim – to ascertain the described monitoring characteristic variable, such as the temperature characteristic variable of the sleeve portion inserted into the induction coil and/or the sleeve characteristic variable of the sleeve portion inserted into the induction coil and/or the time characteristic variable for the heating process of the sleeve portion inserted into the induction coil.

The training, which is generally carried out by means of so-called training data (or in the form of so-called training data vectors) – and with as many of those as possible – can thus be carried out for example using the characteristic variables provided to the self-learning system or the neural network/decision tree (cf. the at least one characteristic variable or the plurality of different characteristic variables or the at least one further characteristic variable, such as in particular a current and/or a voltage, such as in particular a coil current and/or a coil voltage and/or an input current and/or an input voltage and/or a link circuit current and/or a link circuit voltage, and/or in particular an instantaneous change of the coil current and/or an instantaneous rate of change of the coil current and/or an absolute coil voltage and/or an absolute coil current and/or an energy from a coil current that has been flowing since the start of heating and/or an integral of the instantaneous coil current (active current) that has been flowing since the start of heating and/or a heating time since the start of heating and/or an instantaneous inductance of the induction coil or of an overall system comprising the induction coil and the sleeve portion and/or an instantaneous phase angle between an instantaneous coil current (active current) and a coil voltage driving it and/or a time (duration) within which the coil current or link circuit current experiences a predefinable change, for example an increase) – in particular also including/with the monitoring characteristic variable to be supplied in an associated manner by the self-learning system or the neural network/decision tree (cf. such as the temperature characteristic variable of the sleeve portion inserted into the induction coil and/or the sleeve characteristic variable of the sleeve portion inserted into the induction coil and/or the time characteristic variable for the heating process of the sleeve portion inserted into the induction coil) ("training data/vector").

These training data can be determined by heating processes carried out in a defined manner, in particular can be measured there or can be ascertained from variables measured there. In particular, they can be obtained by heating processes carried out on measuring cones, in which it is possible to acquire – for or during these “defined” heating processes – thus applied (, measured) characteristic variables with the respectively associated (measured) monitoring characteristic variables.

For example, these (measured) training data can be obtained with a "resolution" of 5, 10 or 20 values per second during heating.

Moreover, associated monitoring characteristic variables can be acquirable by way of user feedback and/or user interactions. In other words, here the self-learning system or neural network/decision tree can be trained with user feedback and/or user interactions.

In order to increase the performance of the self-learning system or the neural network, provision can be made for carrying out the training using a backpropagation method.

In a development – in order to improve the self-learning system or the neural network – the self-learning system or the neural network can also be retrained, in particular using user feedback and/or user interactions.

Irrespective of that, it is important during training to include a plurality of data sources in order to enable comprehensive modelling. This can comprise real measurement data, simulated scenarios or else synthetic data in order to prepare the system for rare or extreme conditions.

These data can be used to prepare the self-learning system or the neural network/decision tree for different scenarios – including those that may rarely occur in practice. Such data help to improve the robustness and generalization capability of the model.

The invention is based on the insight that complex processes are difficult if not impossible to describe by means of (accurate) analytics and thus process variables that can be ascertained by the analytics are insufficiently accurate. A control set up on the basis thereof is thus subject to operational safety risks. That is to say that – here in the case of (inductive) heating of a tool holder – a purely "analytically structured" monitoring and control for an (inductive) heating process for sleeve portions or tool holders on the basis of analytically ascertained variables (for example from our copending patent application No. 19/344,873 and its counterpart German patent application DE 10 2024 128 298.3) may have safety risks.

However, self-learning systems, such as neural networks or decision trees, provide an instrument which is suitable for (more accurately) representing or describing complex processes, such as here the (inductive) heating process of sleeve portions, by virtue of the self-learning system or the neural network/decision tree learning the process (on the basis of (training) data). The self-learning system or neural network/decision tree creates – as it were – an image of the process/process of heating (heating process), which can then be used to ascertain process parameters, such as the monitoring characteristic variables, – for monitoring and also control. On the basis thereof, the process can then be monitored and controlled by open-loop and/or closed-loop control.

Put another way and simply, the self-learning system according to the invention, or the neural network/decision tree, generates reliable process variables with high accuracy, here the monitoring characteristic variables, on the basis of which an operationally safe and error-avoiding (process) monitoring and control (cf. the limit value comparisons for a switch-off mentioned later) can then be set up.

In addition, the approach with the self-learning system according to the invention, or the neural network/decision tree, affords the possibility of also being used predictively. Not only is it possible for the present process status to be monitored – and for anomalies and deviations from the normal state to be identified – but it is also possible for future developments to be predicted. This is particularly valuable for proactive "maintenance" and optimization of operating parameters. Potential failures can be detected at an early stage and remedied (possibly by adaptations) before they lead to expensive outages. This improves reliability and availability.

A combination of (conventional) "analytically based" and "neural" monitoring (and control) may make the monitoring of the inductive heating process even safer.

In addition, the degree of automation can advantageously be increased by means of the invention. If the invention is integrated into an automatically effected inductive heating of a tool holder, for example during an automated tool change, then it is the case that if the characteristic variables in the self-learning system or neural network can be picked off automatically at/during the process – and then the self-learning system or neural network/decision tree ascertains the monitoring characteristic variable, no manual user intervention is necessary during the process. That is to say that the process can be operated – process-reliably – with shorter cycle times with high operational safety.

### Method

In the method for controlling an inductive heating process for an induction coil assembly, for example a shrinking device, with a sleeve portion of a tool holder inserted into an induction coil of the induction coil assembly, it is thus provided that the at least one characteristic variable, in particular the plurality of different characteristic variables, of the induction process is/are provided.

In order to represent the process of heating even better by means of the self-learning system, it is expedient if at least one further characteristic variable, such as an instantaneous change of the coil current and/or an instantaneous change of the link circuit current and/or an instantaneous rate of change of the coil current and/or an instantaneous rate of change of the link circuit current and/or an absolute coil voltage and/or an absolute coil current and/or an energy from a coil current that has been flowing since the start of heating and/or an energy from a link circuit current that has been flowing since the start of heating and/or an integral of the instantaneous coil current (active current) that has been flowing since the start of heating and/or an integral of the link circuit current that has been flowing since the start of heating and/or a heating time since the start of heating and/or an instantaneous inductance of the induction coil or of an overall system comprising the induction coil and the sleeve portion and/or an instantaneous phase angle between an instantaneous coil current (active current) and a coil voltage driving it, is or are provided.

A further such characteristic variable which is to be provided/providable can be a time (duration) within which the coil current or link circuit current experiences a predefinable change, for example an increase. For example, this can be the time (duration) that the coil current or link circuit current requires to rise from a first (lower) limit value, such as 0 A, to a second (upper) limit value, such as a maximum predefinable current intensity. This would be the case, for example, with a coil current or link circuit current with an applied test pulse (see later with regard to the test pulse).

Irrespective of that, such a characteristic variable can be a variable ascertained using the at least one characteristic variable or the plurality of different characteristic variables, for example by integration, differential formation or the like, such as the energy as integral of the coil current (active current).

It may be expedient if a characteristic variable provided to the self-learning system passes through a digital smoothing filter, for example a Kalman filter, before it is supplied to the learning system. This filter is particularly suitable for real-time data processing because it continuously updates predictions and incorporates measurements to generate more precise estimates. It is ideal for dynamic systems such as the induction process, where the states can change quickly. The use of adaptive algorithms can optimize filter performance by virtue of these algorithms dynamically adapting to the changing conditions of the heating process.

The term "provided" may also mean that the at least one characteristic variable or the plurality of different characteristic variables and/or the at least one further characteristic variable is/are effected by measurement before and/or during, in particular during, the heating process or by making available values, in particular stored or calculated values, for the at least one characteristic variable or the plurality of different characteristic variables and/or the at least one further characteristic variable.

The characteristic variables can also be "provided" by measurements, for example by corresponding sensors or sensor technologies, in particular sensors with IoT technologies.

The at least one characteristic variable or the plurality of different characteristic variables - or same and the at least one further characteristic variable - is/are supplied to the learning system.

The learning system, using the characteristic variables supplied to it, ascertains a monitoring characteristic variable, such as a temperature characteristic variable of the sleeve portion inserted into the induction coil and/or a sleeve characteristic variable of the sleeve portion inserted into the induction coil and/or a time characteristic variable for the heating process of the sleeve portion inserted into the induction coil.

By way of example, the temperature characteristic variable can be a sleeve portion temperature of the tool holder; the sleeve characteristic variable can be a geometry specification for the sleeve portion or the tool holder, in particular a tool holder size, or a specification classifying (or describing) the sleeve portion or the tool holder; the time characteristic variable can be a residual heating duration.

The heating process is monitored using the monitoring characteristic variable, such as the temperature characteristic variable and/or the sleeve characteristic variable and/or the time characteristic variable.

Furthermore, it can also be provided that the heating of the sleeve portion is terminated (or at least changed) if the monitoring characteristic variable and/or one of the characteristic variables supplied to the self-learning system reaches or exceeds or undershoots a definable limit value. This can ensure that the heating process also takes place operationally safely.

It appears to be expedient if a heating parameter and/or a switch-off parameter is defined or readjusted using the ascertained monitoring characteristic variable, and on the basis of said parameter then the heating process is monitored or the heating process is carried out or controlled. Again, it can be provided that the heating of the sleeve portion is terminated (or at least changed) if such a parameter reaches or exceeds or undershoots a definable limit value.

In a development – in order to further increase the degree of automation of the heating – it can be provided that before the start – in particular in an automated manner – the geometry, for example the external diameter or the like, of the sleeve portion inserted into the induction coil is ascertained – and thus the inserted sleeve portion is "recognized".

This is described for example in my earlier patents US 11,166,345 B2, US 12,156,317 B2 (DE 10 2015 016 831.2; EP 2019 17 6562.7) and patent application US 2020/0367324 A1 (DE 10 2019 112 521.9). My earlier disclosures are hereby incorporated by reference.

If the inserted sleeve portion then is deemed to have been recognized or has been recognized, then heating parameters, such as also the characteristic variables made available or the characteristic variables supplied to the self-learning system, can be defined for the inserted sleeve portion or the heating process thereof.

Such heating parameters can in particular also be a shrinkage/heating frequency and/or a shrinkage/heating temperature and/or a time for the heating process and/or a maximum time for the heating process and/or an energy (current integral). It is then possible to define therefrom also limit values for the heating process (in particular for "neural" monitoring and/or "analytical" monitoring).

Furthermore, in a further preferred development, it can be provided that – not just one decision tree, but rather – a plurality of decision trees are used.

In particular, it can be expedient to use a plurality of identically structured decision trees. Each decision tree can be trained on the same output variable or output parameter (and all the output variables can then influence (e.g. proportionally) a resulting final output variable) – and thus the reliability or prediction quality of the monitoring variable can be improved in the combination of all the decision trees.

### Assembly

In the case of the induction coil assembly - for carrying out the method - according to the invention the self-learning system according to the invention is provided.

The self-learning system – as mentioned – ascertains the monitoring characteristic variable using the characteristic variables provided.

Moreover, at least one current and/or voltage detector – either in a link circuit of a frequency converter serving to supply the coil circuit with electrical energy and/or in a coil circuit with the induction coil - can be provided in the induction coil assembly.

It may be expedient if the induction coil assembly provides a comparator for a comparison of at least one of the aforementioned characteristic variables, such as in particular the monitoring characteristic variable and/or one of the characteristic variables supplied to the self-learning system, with a definable limit value.

In order to increase operational safety, it is expedient if the induction coil assembly also has an automatic switch-off unit configured to switch off (or at least change) the heating process by the induction coil if the aforementioned definable limit value is reached or undershot or exceeded during the comparison.

In a development, in order to further improve the induction coil assembly technically, it can be provided that at least two, in particular parallel-running, self-learning systems which then expediently ascertain different monitoring characteristic variables, such as the temperature characteristic variable and the time characteristic variable or the sleeve characteristic variable and the time characteristic variable or the sleeve characteristic variable and the temperature characteristic variable, are provided in the induction coil assembly.

In order to further increase the operational safety of the induction coil assembly, it can be expedient for the circuit also to have at least one power semiconductor component, in particular at least one insulated gate bipolar transistor (IGBT) and/or a metal oxide semiconductor field effect transistor (MOSFET); these have good forward behavior, high reverse voltages and robustness - and are also able to be driven with almost no power.

Since, by virtue of the method, and in the case of the induction coil assembly as well, it is possible to carry out largely automatic or automated operation, that is to say the inductive shrink-fitting of tools into tool holders, in particular the heating of the tool holders, for a respective tool holder just inserted in the induction coil assembly, manual interventions for the purpose of setting operating parameters become superfluous in this case, meaning that, on the one hand, the time previously required for this is saved and, on the other hand, the automatic/automated operation also makes it possible to comply with high standards with regard to operational safety and tolerances in order to be able to ensure that the assembly is operated in accordance with regulations. Efficient protection against overheating of a tool holder to be heated/expanded can also be achieved by virtue of the method and in the case of the induction coil assembly. Power output can be optimized in order to reduce energy consumption and increase efficiency.

The description of advantageous configurations of the invention given so far includes numerous features that are reproduced in the individual dependent claims, in some cases in combination as a plurality. However, these features can expediently also be considered individually and combined into appropriate further combinations.

In particular, these features can each be combined individually and in any suitable combination with the methods according to the invention and/or devices according to the invention.

Even if in the description or in the patent claims some terms are each used in the singular or in combination with a numeral, the scope of the invention is not intended to be limited to the singular or the respective numeral for these terms. Furthermore, the terms “a” or “an” should not be understood as numerals, but as indefinite articles.

The above-described properties, features and advantages of the invention and the manner in which they are achieved will become clearer and more clearly understandable in association with the following description of the exemplary embodiments of the invention which are explained in greater detail in association with the drawing(s)/figure(s) (identical component parts/components and functions have the same reference signs in the drawings/figures).

The exemplary embodiments are used to explain the invention and do not restrict the invention to combinations of features specified therein, not even in regard to functional features. For this purpose, it is moreover also possible for suitable features of each exemplary embodiment to be considered explicitly in isolation, removed from one exemplary embodiment, inserted into another exemplary embodiment in order to supplement the latter, and combined with any one of the claims.

Other features which are considered as characteristic for the invention are set forth in the appended claims.

Although the invention is illustrated and described herein as embodied in an induction coil assembly and method for monitoring an inductive heating process for an induction coil assembly and also self-learning system for monitoring an inductive heating process and method for training the self-learning system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows an induction coil assembly in accordance with one embodiment in center-longitudinal section;

FIG. 2 shows a circuit diagram of a circuit for feeding an induction coil able to be used for the induction coil assembly according to FIG. 1;

FIG. 3 shows a neural network used for monitoring a heating process in the induction coil assembly according to FIG. 1;

FIG. 4 shows coil current profiles for various tool holders in regard to a test pulse in the induction coil assembly according to FIG. 1; and

FIG. 5 shows decision trees used for monitoring a heating process in the induction coil assembly according to FIG. 1.

### DETAILED DESCRIPTION OF THE INVENTION

Automated heating control of a shrinkage process with a shrinking device / monitoring of the inductive heating process by means of a self-learning system (neural network or decision trees)

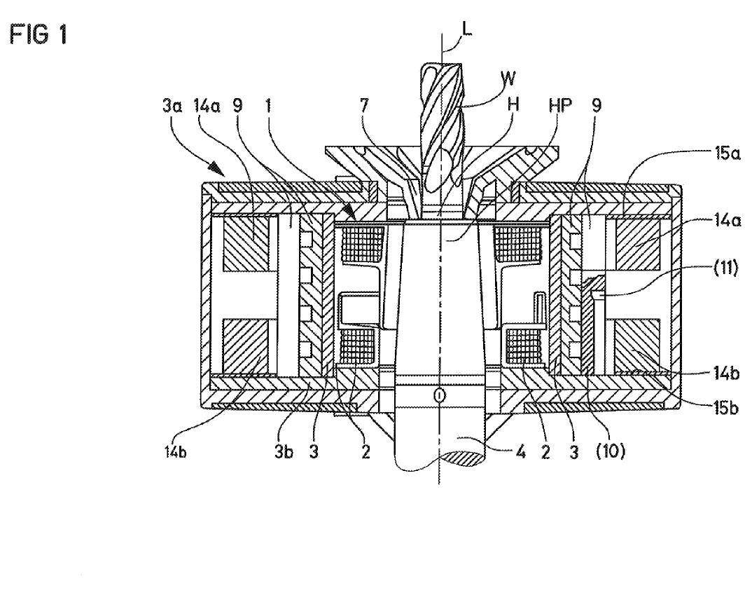

FIG. 1 shows a basic structure of an induction coil assembly, which will also be referred to (hereinafter) as a shrinking device (also shrinking apparatus) owing to its intended function here.

### Induction Coil Assembly/Shrinking Device

As illustrated in FIG. 1, the shrinking device provides an induction coil 1 having individual turns 2, in the center of which a tool holder 4 is inserted in order to shrink-fit or remove the holding shaft H of a tool W, such as here a milling cutter for example, into or from the sleeve portion HP.

The operating principle on which the shrink-fitting and removal is based is described in more detail in German Patent Application DE 199 15 412 A1. The content thereof is hereby incorporated into the subject matter of this application.

On its outer circumference, the induction coil 1 is provided with a first sheath 3 composed of electrically non-conductive and magnetically permeable material.

Typically, the first sheath 3 consists of either a ferrite or a metal powder or metal sintered material, the individual particles of which are isolated from one another in electrically insulated fashion and which are thereby, on the whole, substantially magnetically permeable and electrically non-conductive.

The first sheath 3 is also designed such that it is completely self-enclosed in the circumferential direction, that is to say completely covers the peripheral surface of the induction coil 1, such that, in theory, there are also no remaining "magnetic gaps" whatsoever, aside from irrelevant local penetrations, such as individual and/or small local bores or the like.

As FIG. 1 also shows, in the shrinking device, the shielding composed of magnetically permeable and electrically non-conductive material does not end with the first sheath 3.

Instead, a magnetic cover 3a, 3b composed of said material adjoins at least one, better still both end faces of the first sheath 3, and is generally in contact with the first sheath 3.

On the end face of the induction coil 1 remote from the tool holder 4, the magnetic cover 3a is preferably designed as a completely or preferably partially replaceable pole shoe, i.e. as a ring-shaped structure having a central opening, which forms a passage 7 for the tool W to be clamped in or released.

On the end face of the induction coil 1 facing the tool holder 4, the magnetic cover 3b is preferably designed as an inherently planar annular disk, which ideally fully engages over the windings of the induction coil 1 and has a central passage for the sleeve portion HP.

In order to even further improve the shielding, as FIG. 1 also shows, the induction coil 1 and its first sheath 3, on the outer circumference thereof, are surrounded by a second sheath 9 – specifically such that the first sheath 3 and the second sheath 9 touch one another, ideally over the majority of or the entirety of their mutually facing peripheral surfaces.

This second sheath 9 is produced from magnetically impermeable and electrically conductive material, for example aluminum.

"Electrically conductive" is understood here to mean a material that is electrically conductive not just locally, "grain-by-grain" so to speak, but rather a material that permits the formation of eddy currents to a relevant extent.

The special feature of the second sheath 9 is that it is preferably designed, and preferably designed to be thick enough in the radial direction, that eddy currents are produced therein under the influence of the stray field of the induction coil 1 penetrating it, these eddy currents causing a weakening of the undesired stray field.

The second sheath 9 is also surrounded, on its circumference, by the power semiconductor components 10, which will be explained in more detail below, which are arranged directly on the outer circumference of the second sheath 9 in recesses 11 there (only indicated).

These power semiconductor components 10 have two large main surfaces and four small side surfaces. The large main surfaces are preferably more than four times larger than each of the individual side surfaces.

The power semiconductor components 10 are arranged such that one of their large main surfaces is in thermally conductive contact with the second sheath 9, generally on the outer circumference thereof, wherein the relevant large main surface of the power semiconductor component 10 is adhesively bonded to the peripheral surface of the second sheath 9 by way of a thermally conductive adhesive.

Each of the power semiconductor components 10 has different voltage supply terminals.

Furthermore, as FIG. 1 also shows, capacitors 14a, 14b are grouped together around the induction coil 1 on the outer circumference thereof.

The capacitors 14a are preferably smoothing capacitors that are directly part of a power circuit; the capacitors 14b are preferably resonant circuit capacitors that are likewise directly part of the power circuit.

In order to electrically connect the capacitors 14a, 14b, provision is made here of multiple electrical circuit boards 15a, 15b, each engaging around the outer circumference of the induction coil 1.

Each of these circuit boards 15a, 15b preferably forms an annular disk. Each of the circuit boards 15a, 15b preferably consists of FR4 or similar materials commonly used for circuit boards.

As may also be seen in FIG. 1, the axis of rotational symmetry of each of the two circuit boards 15a, 15b, designed here as circuit board annular disks, is coaxial here to the longitudinal axis L of the induction coil (also of the tool holder 4/tool W).

The upper one of the two electrical circuit boards 15a carries the smoothing capacitors 14a, the connection tabs of which penetrate the upper circuit board 15a or are connected to the upper circuit board 15a using SMD technology, such that the smoothing capacitors 14a hang down from the upper circuit board 15a.

The lower one of the two circuit boards 15b is designed accordingly, and the resonant circuit capacitors 14b protrude upward therefrom.

In summary, the power semiconductors 10 form a first imaginary cylinder that surrounds the induction coil 1; the capacitors 14a, 14b form a second imaginary cylinder that surrounds the first imaginary cylinder; the capacitors 14a, 14b, which are only less sensitive to the stray field, form the imaginary, outer cylinder, while the power semiconductor components 10, which rely on an installation space with as few stray fields as possible, form the imaginary, inner cylinder.

As FIG. 1 also shows, the induction coil 1 is not "fully wound" over its entire length in the direction of its longitudinal axis L. Instead, it consists – here – of two winding packages, which are generally cylindrical. These each form an end face of the induction coil 1. They keep a distance from one another that – by way of example here – is greater by approximately at least a factor of 1.5 than the extent of each of the winding packages in the direction of the longitudinal axis L of the induction coil 1.

Such an induction coil 1 contributes to reducing reactive power, since it does not have the windings in the "central area", which are not necessarily required from the point of view of achieving the most effective possible heating of the sleeve portion HP of the tool holder, but which – if present – have the tendency to produce additional reactive power, without making a really important contribution to heating.

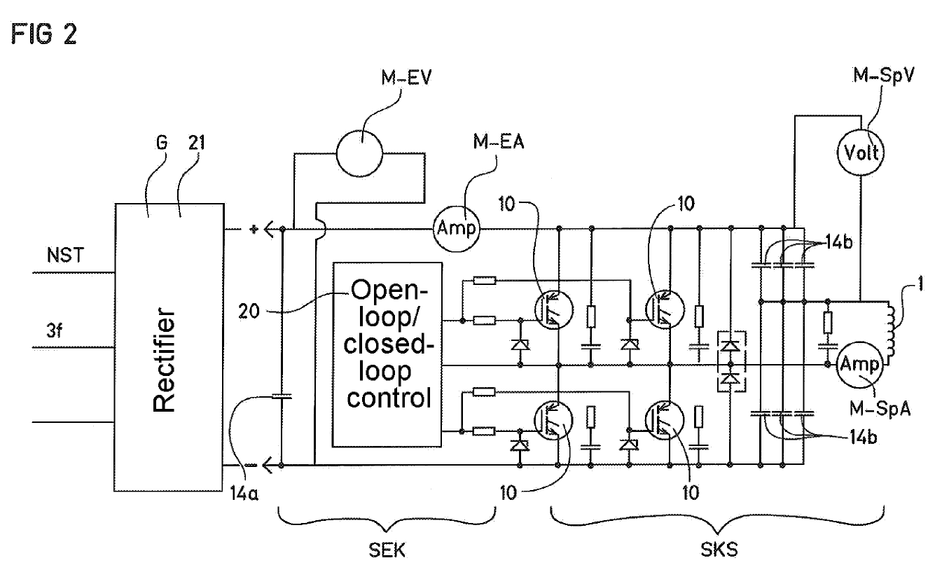

In order to supply the induction coil 1 – with as few losses as possible – provision is made of a circuit – illustrated in more detail in FIG. 2.

### Circuit

As shown in FIG. 2, to this end, this circuit has a resonant circuit SKS. In the resonant circuit SKS, the majority of the required energy oscillates periodically back and forth (at high frequency) between the induction coil 1 and a capacitor unit 14a, 14b. This means that, in each period or periodically, only the energy extracted from the resonant circuit SKS through its heating power and its other power losses needs to be fed back. The previous very high losses are thus no longer incurred.

The power electronics supplying power to the induction coil 1, as shown in FIG. 2, are supplied on the input side with the generally available grid current NST, which, in the US would be the generally available industrial and commercial three-phase utility service at 480 V / 60 Hz, three-phase (3φ), equivalent to the European grid three-phase current, 3f, is 400 V / 50 Hz.

The current drawn from the grid, as illustrated in FIG. 2, is converted, by a rectifier G 21, into direct current, which in turn is smoothed by the one or more smoothing capacitors 14a (not shown).

As furthermore also illustrated in FIG. 2, this direct current is supplied to the actual resonant circuit SKS.

The backbone of the resonant circuit SKS is formed by the power semiconductor components 10, the resonant circuit capacitors 14b and the induction coil 1, which serves for shrink-fitting and removal from a shrink-fit.

The resonant circuit SKS is controlled by open-loop and/or closed-loop control by control electronics SEK, which are supplied with direct current from the rectifier G.

The power semiconductor components 10 are preferably implemented by insulated gate bipolar transistors, IGBT for short.

The control electronics SEK switch the power semiconductor components 10/IGBT at a frequency that specifies the operating frequency that sets in at the resonant circuit SKS.

It is important that the resonant circuit SKS never operates exactly in resonance.

This would result here in the rapid destruction of the power semiconductor components 10 as a result of the voltage peaks. Instead, the control electronics SEK are designed such that they operate the power electronics or their resonant circuit SKS in a predefinable working range, which is only close to the resonance or natural frequency of the system.

Preferably, the resonant circuit is controlled by open-loop and/or closed-loop control (by means of the control 20) such that 0.9 ≤ cos φ ≤ 0.99. Values in the range 0.95 ≤ cos φ ≤ 0.98 are particularly expedient. This again leads to voltage spikes being avoided, and therefore provides further support for miniaturization.

### Monitoring the Shrinking/Heating Process - Overheat Protection

In order to operate the shrinking device with a certain degree of operational safety – in a manner as automated as possible – the shrinking device is equipped with an automatic heating open-loop/closed-loop control, which enables automated shrinking operation.

This heating open-loop/closed-loop control is implemented by a corresponding open-loop and/or closed-loop control 20 in the shrinking apparatus, this control also including overheating protection for a tool holder 4 presently inserted into the induction coil for shrinking purposes (in order to prevent possible damage to the tool holder presently to be subjected to shrinking as a result of the overheating thereof).

What are essential for the open-loop and/or closed-loop control 20 - and also for the overheating protection – are the currents and voltages that arise in the circuit, i.e. here in particular coil current M-SpA, coil voltage M-SpV and also link circuit current M-EA and/or link circuit voltage M-EV.

In order to measure coil current (M-SpA), coil voltage (M-SpV) and link circuit current (M-EA) and link circuit voltage (M-EV), the circuit, as also shown in FIG. 2, accordingly provides current/voltage measuring devices M-SpA (coil current), M-SpV (coil voltage) and M-EA (link circuit current) and M-EV (link circuit voltage), which are installed in the circuit at correspondingly shown positions and in a corresponding manner. These measuring devices deliver the corresponding measured values with sampling of 10 values per second.

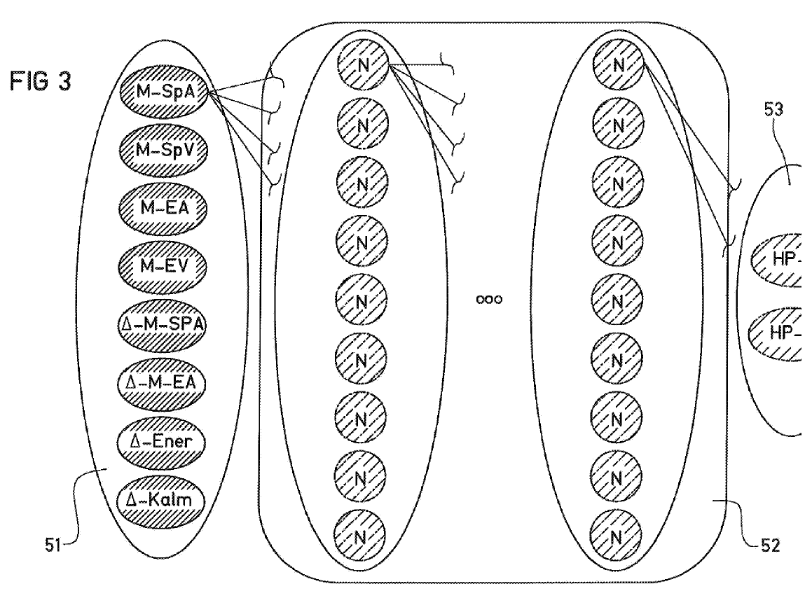

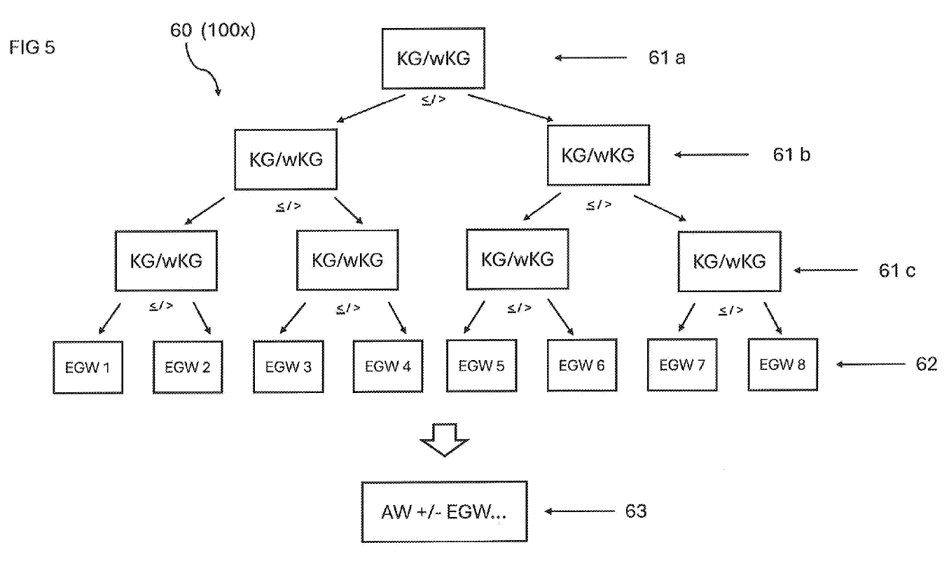

If in this case the measured variables or else their profile, in the case of an induction coil used for shrinking, also depend on the temperature of the inserted sleeve portion of the tool holder, then this or these variables can advantageously be used for – automated – monitoring or heating control on a neural basis (cf. FIG. 3, neural network 50, cf. FIG. 5, decision trees 60), in order thus – while avoiding "manual" sources of errors because it is automated - to improve safety in a shrinking device.

In short – the abovementioned variables (measurable by the measuring devices) coil current M-SpA, coil voltage M-SpV and also link circuit current M-EA and/or link circuit voltage M-EV are (besides other characteristic variables – see later) supplied – as input variables – to a neural network 50 (cf.

FIG. 3) (or decision trees 60, FIG. 5), which – in the former exemplary embodiment – neural network 50 outputs the temperature of the inserted sleeve portion of the tool holder HP-Temp – as one possible output variable.

In addition, the neural network 50 (cf. FIG. 3) also outputs a residual heating duration HP-t – as another possible output variable. This residual heating duration (HP-t), which is output at a specific/present time t by the neural network 50, describes the length of time for which – proceeding from the specific/present time – the heating process still needs to be carried out in order to ensure an "optimal" shrinkage. "Optimal shrinkage" may be characterized in that it can be carried out non-destructively, with tool removable and insertable and with the shortest possible duration.

The abovementioned characteristic variables supplied to the neural network 50 as further input variables are in this case so-called delta variables, which can be derived or calculated from the abovementioned current and voltage variables, specifically a delta coil current Δ-M-SpA, a delta link circuit current Δ-M-EA and also a delta energy Δ-Ener and a delta Kalman Δ-Kalm.

The further characteristic variable delta coil current Δ-M-SpA is based on a derivative of the coil current; the further characteristic variable delta link circuit current Δ-M-EA is based on a derivative of the link circuit current; the further characteristic variable delta energy Δ-Ener is the amount of energy introduced into the present tool holder or sleeve portion to be subjected to shrinking during heating (cf. integral of the coil current); the further characteristic variable delta Kalman Δ-Kalm is the output of a Kalman filter supplied with the delta link circuit current M-EA.

The inductive heating is then carried out – in a manner controlled by the open-loop and/or closed-loop control 20 – until the first of the output variables mentioned reaches its respective switch-off criterion. That is to say either until the temperature of the presently inserted sleeve portion of the tool holder HP-Temp reaches a predefined maximum temperature or the residual heating duration HP-t has fallen to a "residual duration zero". The induction coil is then switched off automatically.

This "neural" open-loop and/or closed-loop control 20 and/or overheating protection can also be overlaid by an analytical open-loop and/or closed-loop control 20 and/or overheating protection. For example using further characteristic variables, such as a predefined maximum heating time and/or the amount of energy (introduced into the present tool holder or sleeve portion to be subjected to shrinking). For this purpose, during a heating process, in each case the actual present heating duration is measured and (continuously) the amount of energy introduced into the sleeve portion up to a present time (integral of the instantaneous coil current (active current) that has been flowing since the start of heating) is determined. If the (measured) actual present heating duration reaches "its" limit value predefinable individually (for the tool holder presently to be subjected to shrinking) or if the amount of energy reaches "its" individually predefined limit value, then here as well the heating process is terminated or the induction coil is switched off.

Other characteristic variables mentioned here in the application, such as inductance or phase angle, can be used as further switch-off criteria in a corresponding manner.

### Neural Network

FIG. 3 shows the neural network 50. The neural network 50 provides an input layer 51, - in this case - 32 hidden layers 52 and an output layer 53.

The input layer 51 – having eight (input) neurons – is supplied with the abovementioned (characteristic) variables of coil current M-SpA, coil voltage M-SpV and also link circuit current M-EA and link circuit voltage M-EV – and also the further characteristic variables, delta coil current M-SpA, delta link circuit current M-EA and also delta energy and delta Kalman.

The neural network 50 ascertains the monitoring characteristic variables that can be picked off at the output layer 53 – having two (output) neurons –, the temperature of the inserted sleeve portion of the tool holder HP-T and also the present residual heating duration HP-Rt.

ReLu and sigmoid are used as activation functions.

### Training of the Neural Network

In order to train the neural network 50, measurements are carried out on defined measuring cones or during heating processes pertaining to the measuring cones "shrunk" by the shrinking device. In this case – in addition to the measured currents and voltages – a temperature sensor also measures the temperature at the sleeve portion of the inserted measuring cone. The present residual heating duration formed from the maximum heating duration (of the "shrinking" presently being carried out) minus the heating time that has elapsed since the start of the "shrinking" presently being carried out is calculated.

The measured values (currents, voltages, temperature) and also the present residual heating duration are collected – according to the sampling rate – with here 10 values per second for the (total) heating duration of the "shrinking" carried out.

The multiplicity of training data vectors formed therefrom are used for the training of the neural network.

Alternative: Instead of the neural network 50 described here, which provides the two output variables/monitoring characteristic variables, the temperature of the inserted sleeve portion of the tool holder HP-T and also the present residual heating duration HP-Rt, two neural networks operating in parallel can also be used.

Both are each supplied with the above-described (characteristic) variables of coil current M-SpA, coil voltage M-SpV and also link circuit current M-EA and link circuit voltage M-EV – and also the further characteristic variables, delta coil current M-SpA, delta link circuit current M-EA and also delta energy and delta Kalman. The first neural network outputs the temperature of the inserted sleeve portion of the tool holder HP-T and the second neural network outputs the present residual heating duration HP-Rt.

The training for the two networks is carried out according to the one "overall network" (neural network 50).

### Automatic recognition of the tool holder/sleeve portion presently inserted into the shrinking device or the induction coil thereof

Before the start of heating of the sleeve portion (HP, cf. FIG. 1) inserted into the induction coil (1, cf. FIGS. 1 and 2), the geometry or the external diameter of the sleeve portion inserted into the induction coil is first of all ascertained - in automated fashion – and the inserted sleeve portion is thus "recognized".

This takes place in particular by virtue of the fact that a test pulse with known current magnitude, current waveform, frequency and duration of action is applied to the induction coil still before the start of an actual inductive heating process for the sleeve portion inserted into the induction coil, for this test pulse a time/current curve is ascertained for the sleeve portion inserted into the induction coil and the time/current curve ascertained for the test pulse as a whole is taken as a – geometry-determining – magnetic fingerprint for the sleeve portion inserted into the induction coil.

This is described for example in my above-noted, earlier patents US 11,166,345 B2, US 12,156,317 B2 (DE 10 2015 016 831.2; EP 2019 17 6562.7) and patent application US 2020/0367324 A1 (DE 10 2019 112 521.9). My earlier disclosures are herein incorporated by reference.

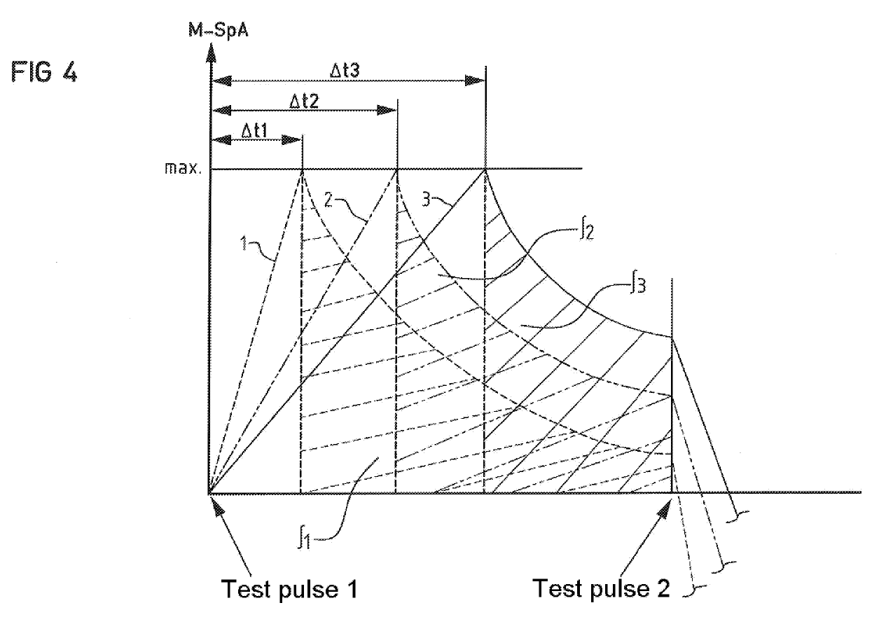

FIG. 4 shows by way of example the time/current curves (curves 1, 2 and 3) for three (different) sleeve portions or tool holders (tool holders 1, 2 and 3) inserted into the induction coil for a defined test pulse. By virtue of the fact that the time/current curves, as can be gathered from FIG. 4, have individual, specific profiles for the three (different) sleeve portions or tool holders inserted into the induction coil, it is thus possible to deduce – from the profile of the time/current curve – the individual sleeve portion or tool holder.

If the inserted sleeve portion then is deemed to have been recognized or has been recognized, then (previously) defined heating parameters can be defined for the inserted sleeve portion or the heating process thereof, such as, inter alia, in particular the (individual) shrinkage/heating frequency.

Alternative: Neural network is also trained on the geometry or external diameter of the sleeve portion inserted into the induction coil – and can thus also ascertain the geometry or external diameter of the sleeve portion inserted into the induction coil.

The heating process of the inserted sleeve portion is then started at its individual shrinkage/heating frequency, wherein, at the same time as power starts being supplied to the induction coil, the measurement of the coil current, of the coil voltage, of the link circuit current and of the link circuit voltage also begins (cf. circuit according to FIG. 2 in this regard).

In this way the described "neural" monitoring and control then enables as far as possible automatic or automated shrinkage. Manual interventions for the purpose of setting operating parameters are superfluous in this case, meaning that, on the one hand, the time previously required for this is saved and, on the other hand, the automatic/automated operation also makes it possible to comply with high standards with regard to operational safety and tolerances in order to be able to ensure that the assembly is operated in accordance with regulations. Efficient protection against overheating of the sleeve portion is also achieved.

(Further) use of the test pulse in the heating supervision (characteristic variable Δt and characteristic variable ʃ) (FIG. 4)

As described above, FIG. 4 shows by way of example the time/current curves for three (different) sleeve portions or tool holders inserted into the induction coil for a defined test pulse.

As FIG. 4 also shows, two further characteristic variables for a tool holder/sleeve portion can be ascertained from such a time/current curve of a particular tool holder/sleeve portion (i.e., characteristic variable Δt, characteristic variable ʃ).

The characteristic variable Δt describes the period of time that – when the test pulse is applied – the coil current needs until it reaches its maximum value (cf. FIG. 4, "max.") (cf. FIG. 4, Δt1, Δt2, Δt3).

The characteristic variable ʃ describes the area beneath the time/current curve for the test pulse (cf. FIG. 4, test pulse 1) during the fall in the coil current after reaching its maximum value - up to a defined point or defined, further predefinable event, here the application of a next test pulse (cf. FIG. 4, test pulse 2) (cf. FIG. 4, ʃ1, ʃ2, ʃ3).

Alternatively, the entire area beneath the time/current curve for the test pulse can also be used for the characteristic variable ʃ.

As FIG. 4 illustrates, both characteristic variables Δt and ʃ are individual, specific to a tool holder/sleeve portion – and thus suitable for describing or defining a specific, particular tool holder. This makes it possible thus to carry out particular supervisory functions during the inductive heating process in the shrinking device – for a tool holder/sleeve portion described by the two characteristic variables Δt and ʃ. hat forms the basis for this is a database of coil current measurements of test pulses on predefined tool holders (representing (approximately) an entire product range) for adjustable coil positions in the case of possible (successful) shrinkage processes in the shrinking device.

The two characteristic variables Δt and ʃ are determined therefrom for each tool holder – respectively for each tool holder in each possible (successful) coil shrinkage position. Each of these defined shrinkage processes can be linked with the respective (successful) shrinkage/heating parameter set ("data set" comprising tool holder, characteristic variable Δt and characteristic variable ʃ, coil position, shrinkage/heating parameters).

This database can then be used for particular supervisory functions in the inductive heating process in the shrinking device.

Supervision of the coil setting by way of the characteristic variables Δt and ʃ

During the supervision of the coil setting for a shrinkage process in the case of a - known - tool holder to be subjected to shrinking, this tool holder is inserted into the shrinking device - and the induction coil is set to a (successful) coil shrinkage position predefined for this known tool holder.

The test pulse is applied – and the coil current is measured and the two characteristic variables Δt and ʃ are determined. In the database a check is made to establish whether a data set exists whose characteristic variables Δt and ʃ (largely) match those of the test pulse.

If this is the case, the coil shrinkage position was set correctly; if no corresponding data set can be ascertained in the database, the setting of the coil shrinkage position is reported back as incorrect.

Determination of the shrinkage parameters by means of the characteristic variables Δt and ʃ

Here, an (unknown) tool holder is inserted into the shrinking device – and the induction coil is set to a (successful) coil shrinkage position that is possible (from the point of view of the experienced operator).

The test pulse is applied – and the coil current is measured and the two characteristic variables Δt and ʃ are determined. In the database, exactly that data set whose two characteristic variables Δt and ʃ therein best match those of the test pulse is determined.

Once this "matching" data set has been identified, the shrinkage parameters for the (unknown) tool holder can be taken from this data set – and the tool holder can be (successfully) subjected to shrinking according to these parameters.

Irrespective of that, the two characteristic variables Δt and ʃ (alone or in combination) can also be supplied to the prescribed neural network as input variables – in addition to the input variables already described. The training data/data sets can be adapted accordingly.

Monitoring the shrinkage/heating process – overheating protection by means of decision trees 60 (FIG. 5)

The decision tree 60 in FIG. 5 provides three decision levels 61a, 61b, and 61c and also one result level 62. Due to the structure, the decision tree thus provides eight result values EGW 1, EGW 2, … EGW 8 (in the result level 62), which are used to correct 63 an assumed initial/starting value AW of a temperature of the inserted sleeve portion of the tool holder HP-T to a (predicted) temperature of the inserted sleeve portion of the tool holder HP-T.

Use is made of – in this case – one hundred of such decision trees 60, each being identically structured, and their correction values then influence the correction by 1% each (in accordance with the one hundred decision trees 60).

The initial/starting value of the temperature of the inserted sleeve portion of the tool holder HP-T, this value having been corrected by all the decision trees or all the correction values thereof, is then the (predicted) temperature of the inserted sleeve portion of the tool holder HP-T (at a specific heating time).

The decision trees 60 are each supplied with - for a heating time t - ten of the (inter alia measured) characteristic variables KG and also five of the further characteristic variables wKG (derived therefrom) of the induction process. For example, the aforementioned (characteristic) variables of coil current M-SpA, coil voltage M-SpV and also link circuit current M-EA and link circuit voltage M-EV – and also the further characteristic variables, delta coil current M-SpA, delta link circuit current M-EA and also delta energy and delta Kalman. Each decision tree 60 takes a decision for its nodes - and delivers the corresponding result value EGW 1, EGW 2, … EGW 8.

With a sampling rate of 30 ms in the induction process, the characteristic variables for the decision trees 60 are made available during the induction process, which decision trees then ascertain the temperatures of the inserted sleeve portion of the tool holder HP-T for these times, as described above.

If an ascertained temperature of the inserted sleeve portion of the tool holder HP-T exceeds a predefined limit temperature, the induction process is terminated.

### Training of the Decision Trees 60

The training of the decision trees is effected by means of CART/Scikit-learn, with a structure being predefined on the three decision levels and the one result level.

The training data are formed as sixteen row vectors with the aforementioned ten characteristic variables KG and five further characteristic variables wKG and also the correction value. The training generates a plurality of decision trees (each with trained node parameters (i.e., certain of the characteristic values) and the decision values thereof) and correction values, from whose plurality of decision trees one hundred "best" decision trees are selected, – and also the aforementioned initial/starting value of the temperature of the inserted sleeve portion of the tool holder HP-T.

For example, a selection criterion for the selected decision trees 60 can be the diversity of the respective node parameters. The more varied the trained decision trees 60 are, the better and more reliable the prediction of the temperature value over the spectrum of possible sleeve portions may be.

If appropriate, normalized characteristic variables can be employed, which can – also – turn out to be the result of the training process.

Although the invention has been illustrated and described in more specific detail by means of the preferred exemplary embodiments, nevertheless the invention is not restricted by the examples disclosed and other variations can be derived therefrom, without departing from the scope of protection of the invention.

1. A method for monitoring an inductive heating process for an induction coil assembly with a sleeve portion of a tool holder inserted in an induction coil of the induction coil assembly, the method comprising:
providing one or more different characteristic variables of the induction process, the one or more characteristic variables including at least one variable selected from the group consisting of a coil current, a coil voltage, an input current, an input voltage, a link circuit current, and a link circuit voltage;
supplying the one or more characteristic variables to a learning system, using the one or more characteristic variables by the learning system to ascertain a monitoring characteristic variable, the monitoring characteristic variable being a variable selected from the group consisting of a temperature characteristic variable of the sleeve portion inserted into the induction coil, a sleeve characteristic variable of the sleeve portion inserted into the induction coil, and a time characteristic variable for the heating process of the sleeve portion inserted into the induction coil; and
monitoring the heating process using the monitoring characteristic variable, including at least one of the temperature characteristic variable, the sleeve characteristic variable, or the time characteristic variable.

2. The method according to claim 1, which comprises:
providing to the learning system at least one further characteristic variable selected from the group consisting of an instantaneous change of the coil current, an instantaneous change of the link circuit current, an instantaneous rate of change of the coil current, an instantaneous rate of change of the link circuit current, an absolute coil voltage, an absolute coil current, an energy from a coil current, link circuit current that has been flowing since the start of heating, an integral of the instantaneous coil current (active current), a link circuit current that has been flowing since the start of heating, a heating time since the start of heating, an instantaneous inductance of the induction coil or of an overall system comprising the induction coil and the sleeve portion, an instantaneous phase angle between an instantaneous coil current (active current) and a coil voltage driving the instantaneous coil current, a time duration within which the coil current or link circuit current experiences a predefined change; and
ascertaining by the learning system the monitoring characteristic variable using the at least one further characteristic variable.

3. The method according to claim 2, wherein:
the step of providing the one or more characteristic variables comprises measuring before or during the heating process or making available stored or calculated values for the one or more characteristic variables; or
the step of providing the at least one further characteristic variable comprises measuring before or during the heating process or making available stored or calculated values for the at least one further characteristic variable.

4. The method according to claim 1, passing a characteristic variable provided to the self-learning system through a digital smoothing filter or subjecting the characteristic variable to normalization before being supplied to the learning system.

5. The method according to claim 1, which comprises terminating or changing the heating of the sleeve portion when the monitoring characteristic variable and/or one of the characteristic variables supplied to the self-learning system reaches, exceeds, or undershoots a definable limit value.

6. The method according to claim 1, wherein the temperature characteristic variable is a sleeve portion temperature of the tool holder, the sleeve characteristic variable is a geometry specification for the sleeve portion or the tool holder, or a specification classifying the sleeve portion or the tool holder, and the time characteristic variable is a residual heating duration.

7. The method according to claim 1, which comprises defining or readjusting at least one of a heating parameter or a switch-off parameter using the ascertained monitoring variable.

8. An induction coil assembly, comprising:
an induction coil formed to receive therein a sleeve portion of a tool holder to be inserted therein;
a self-learning system configured to execute the method according to claim 1 and to ascertain a monitoring characteristic variable by using the one or more characteristic variables, including at least one of a temperature characteristic variable of the sleeve portion inserted into the induction coil, a sleeve characteristic variable of the sleeve portion inserted into the induction coil, or a time characteristic variable for the heating process of the sleeve portion inserted into the induction coil.

9. The induction coil assembly according to claim 8, wherein said self-learning system is configured to ascertain the monitoring characteristic variable using at least one further characteristic variable selected from the group consisting of an instantaneous change of the coil current, an instantaneous change of the link circuit current, an instantaneous rate of change of the coil current, an instantaneous rate of change of the link circuit current, an absolute coil voltage, an absolute coil current, an energy from a coil current, link circuit current that has been flowing since the start of heating, an integral of the instantaneous coil current (active current), a link circuit current that has been flowing since the start of heating, a heating time since the start of heating, an instantaneous inductance of the induction coil or of an overall system comprising the induction coil and the sleeve portion, an instantaneous phase angle between an instantaneous coil current (active current) and a coil voltage driving the instantaneous coil current, and a time duration within which the coil current or link circuit current experiences a predefined change.

10. The induction coil assembly according to claim 8, further comprising at least one current and/or voltage detector either in a link circuit of a frequency converter serving to supply the coil circuit with electrical energy and/or in a coil circuit with the induction coil.

11. The induction coil assembly according to claim 8, further comprising a comparator for comparing at least one of the characteristic variables, including at least one of the monitoring characteristic variable or one of the characteristic variables supplied to the self-learning system, with a limit value predefined for the purpose.

12. The induction coil assembly according to claim 11, further comprising an automatic switch-off unit configured to switch off, or change, the heating process by the induction coil if the limit value is reached or undershot or exceeded during the comparison.

13. The induction coil assembly according to claim 8, which comprises at least two, parallel-running self-learning systems which ascertain different monitoring characteristic variables, including a temperature characteristic variable and a sleeve characteristic variable.

14. A self-learning system for monitoring an inductive heating process, wherein a sleeve portion of a tool holder is inserted in an induction coil for inductive heating, the self-learning system being configured to:
using the one or more characteristic variables as recited in claim 1, ascertain a monitoring characteristic variable, including at least one of a temperature characteristic variable of the sleeve portion inserted into the induction coil, a sleeve characteristic variable of the sleeve portion inserted into the induction coil, or a time characteristic variable for the heating process of the sleeve portion inserted into the induction coil.

15. The self-learning system according to claim 14, wherein the system is configured to ascertain the monitoring characteristic variable using at least one further characteristic variable selected from the group consisting of an instantaneous change of the coil current, an instantaneous change of the link circuit current, an instantaneous rate of change of the coil current, an instantaneous rate of change of the link circuit current, an absolute coil voltage, an absolute coil current, an energy from a coil current, link circuit current that has been flowing since the start of heating, an integral of the instantaneous coil current (active current), a link circuit current that has been flowing since the start of heating, a heating time since the start of heating, an instantaneous inductance of the induction coil or of an overall system comprising the induction coil and the sleeve portion, an instantaneous phase angle between an instantaneous coil current (active current) and a coil voltage driving the instantaneous coil current, and a time duration within which the coil current or link circuit current experiences a predefined change.

16. The self-learning system according to claim 14, being a neural network with a plurality of hidden layers, wherein a number of the hidden layers being more than 10 hidden layers, more than 15 hidden layers, more than 20 hidden layers, more than 25 hidden layers, more than 30 hidden layers, or exactly 32 hidden layers.

17. The self-learning system according to claim 14, being a neural network, wherein an ReLU function or a sigmoid function is used as an activation function in the self-learning neural network.

18. The self-learning system according to claim 14, comprising a plurality of decision trees, wherein identically structured decision trees are used, and wherein a selection of a plurality of neural networks is effected according to a criterion of a diversity of the decision trees.

19. A method for training a self-learning system, the method comprising:
providing the self-learning system being a neural network or decision tree;
training the self-learning system, using the at least one characteristic variable or the plurality of different characteristic variables as recited in claim 1, to ascertain the monitoring characteristic variable, including at least one of the temperature characteristic variable of the sleeve portion inserted into the induction coil, the sleeve characteristic variable of the sleeve portion inserted into the induction coil, or the time characteristic variable for the heating process of the sleeve portion inserted into the induction coil.

20. The method according to claim 19, which comprises also using at least one further characteristic variable for training the self-learning system to ascertain the monitoring characteristic variable, wherein the at least one further characteristic variable is selected from the group consisting of an instantaneous change of the coil current, an instantaneous change of the link circuit current, an instantaneous rate of change of the coil current, an instantaneous rate of change of the link circuit current, an absolute coil voltage, an absolute coil current, an energy from a coil current, link circuit current that has been flowing since the start of heating, an integral of the instantaneous coil current (active current), a link circuit current that has been flowing since the start of heating, a heating time since the start of heating, an instantaneous inductance of the induction coil or of an overall system comprising the induction coil and the sleeve portion, an instantaneous phase angle between an instantaneous coil current (active current) and a coil voltage driving the instantaneous coil current, and a time duration within which the coil current or link circuit current experiences a predefined change.

21. The method according to claim 19, wherein the self-learning system is a neural network or decision tree, and the method further comprises:
using the monitoring characteristic variable, being at least one of the temperature characteristic variable, the sleeve characteristic variable, or the time characteristic variable, for the training, wherein the monitoring characteristic variable used for the training is determined using heating processes that are carried out in a defined manner.

22. The method according to claim 19, wherein the self-learning system is a neural network or decision tree, and the training is carried out using a backpropagation method or a CART and/or Scikit-learn algorithm.

23. The method according to claim 19, wherein the self-learning system is a neural network or decision tree, and the method further comprises retraining the self-learning system using user feedback and/or user interactions.
